(19) United States
(12) Patent Application Publication
(10) Pub. No.: US 2020/0099091 A1
(43) Pub. Date: Mar. 26, 2020

(54) ELECTROLYTIC SOLUTION FOR ELECTROCHEMICAL DEVICE AND ELECTROCHEMICAL DEVICE

(71) Applicant: TAIYO YUDEN CO., LTD., Tokyo (JP)

(72) Inventor: Takeo TSUZUKI, Takasaki-shi (JP)

(21) Appl. No.: 16/569,439

(22) Filed: Sep. 12, 2019

(30) Foreign Application Priority Data
Sep. 25, 2018 (JP) 2018-179416

(51) Int. Cl. H01M 10/0525; H01G 11/54; H01M 10/0569; H01M 10/0567; H01M 10/0568

(52) U.S. Cl. CPC H01M 10/0525; H01G 11/54; H01M 10/0568; H01M 10/0567; H01M 10/0569

(57) ABSTRACT

An electrolytic solution for an electrochemical device, includes: an electrolytic solution in which an electrolyte is dissolved in a solvent, wherein the solvent includes a cyclic carbonate and a chain carbonate at a volume ratio of 25:75 to 75:25, the electrolyte is dissolved in the electrolytic solution at a concentration of 0.8 mol/L to 1.6 mol/L, and includes an imide-based lithium salt and a non-imide-based lithium salt at a molar ratio of 1:9 to 10:0, and a lithium oxalate salt is added to the electrolytic solution at a concentration of 0.1 wt % to 2.0 wt %.

### CROSS-REFERENCE TO RELATED APPLICATION

This application is based upon and claims the benefit of priority of the prior Japanese Patent Application No. 2018-179416, filed on Sep. 25, 2018, the entire contents of which are incorporated herein by reference.

### FIELD

A certain aspect of the present disclosure relates to an electrolytic solution for an electrochemical device, and an electrochemical device.

### BACKGROUND

Electrochemical devices such as electric double layered capacitors and lithium ion capacitors using a nonaqueous electrolyte are able to store large energy therein because of their increased withstand voltages due to high electrolysis voltages of their nonaqueous solvents.

In recent years, the electrochemical devices are requested to reduce the internal resistance at low temperatures and ensure the reliability under high-temperature conditions. Regarding the low-temperature characteristics, it is considered that the internal resistance may increase because the electrolytes may be less likely to dissociate in the electrolytic solution, or the viscosity of the nonaqueous electrolyte may increase.

Regarding the high-temperature reliability, it is considered that the characteristics of cells may deteriorate because degradation products such as hydrogen fluoride caused by decomposition of anions such as PF₆⁻ acting as the electrolyte are generated, or a high-resistance coating film may be formed because of reductive decomposition of the nonaqueous electrolyte near the negative electrode.

To solve the above problems, Japanese Patent Application Publication No. 2017-017299 (hereinafter, referred to as Patent Document 1) discloses a lithium ion capacitor that uses an imide-based lithium salt having an imide structure, and uses a binder including a polymer of which the relative energy difference (RED) value based on Hansen parameters is greater than 1.

Japanese Patent Application Publication No. 2016-503571 (hereinafter, referred to as Patent Document 2) discloses a lithium ion secondary battery in which multiple additives are added to the electrolytic solution including a non-aqueous organic solvent, an imide-based lithium salt, and LiPF₆.

International Publication No. 2016/006632 (hereinafter, referred to as Patent Document 3) discloses a lithium ion capacitor in which a specific additive is added to the electrolytic solution including a mixed solvent of a chain carbonate and a cyclic carbonate, one of LiPF₆ and LiBF₄, and LiFSI.

### SUMMARY OF THE INVENTION

According to an aspect of the present disclosure, there is provided an electrolytic solution for an electrochemical device, including: an electrolytic solution in which an electrolyte is dissolved in a solvent, wherein the solvent includes a cyclic carbonate and a chain carbonate at a volume ratio of 25:75 to 75:25, the electrolyte is dissolved in the electrolytic solution at a concentration of 0.8 mol/L to 1.6 mol/L, and includes an imide-based lithium salt and a non-imide-based lithium salt at a molar ratio of 1:9 to 10:0, and a lithium oxalate salt is added to the electrolytic solution at a concentration of 0.1 wt % to 2.0 wt %.

According to another aspect of the present disclosure, there is provided an electrochemical device including: a power storage element in which a separator is sandwiched between a positive electrode and a negative electrode, wherein at least one of an active material of the positive electrode, an active material of the negative electrode, and the separator is impregnated with the above electrolytic solution.

### BRIEF DESCRIPTION OF THE DRAWINGS

FIG. 1 is an exploded view of a lithium ion capacitor;

FIG. 2 is a cross-sectional view of a positive electrode, a negative electrode, and a separator of the lithium ion capacitor in a stacking direction;

FIG. 3 is an exploded view of a lithium ion capacitor; and

FIG. 4 is an external view of the lithium ion capacitor.

### DETAILED DESCRIPTION

Patent Document 1 describes that use of LiFSI as the imide-based lithium salt and use of the binder including a polymer of which the RED value based on Hansen parameters is greater than 1 enhance the reliability of the float of the lithium ion capacitor at high temperatures around 85° C.

However, the low-temperature characteristics are discussed only from the perspective of the presence or absence of the precipitation of electrolytes and the value of the ionic conductivity, but the cell is not specifically evaluated. Patent Document 2 describes that output characteristics at a low temperature (−30° C.) and a high temperature (60° C.) are improved by adding at least one selected from a group consisting of lithium difluoro (oxalate) phosphate, trimethylsilyl propyl phosphate, 1,3-propene sultone, and ethylene sulfate to the electrolytic solution including a nonaqueous organic solvent, an imide-based lithium salt, and LiPF₆.

However, the output characteristics are evaluated at only up to 60° C., and it is not clear whether the lithium ion secondary battery can withstand high temperatures such as 85° C. In Patent Document 3, used is a mixed solvent made of one of ethylene carbonate (EC) and propylene carbonate (PC) and one of dimethyl carbonate (DMC), diethyl carbonate (DEC), and ethyl methyl carbonate (EMC). One of LiPF₆ and LiBF₄, and LiFSI are added, as electrolytes, to the mixed solvent to make an electrolytic solution. Furthermore, Patent Document 3 describes that a compound of one of chain ether, fluorinated chain ether, and propionate ester is added to the electrolytic solution, or a compound of one of sultone, cyclic phosphazene, fluorine-containing cyclic carbonate, cyclic carbonic ester, cyclic carboxylic acid ester, and cyclic acid anhydride is added to the electrolytic solution. Patent Document 3 describes that this configuration improves the output characteristics of the lithium ion capacitor at −30° C., and generation of gas when the lithium ion capacitor is stored at 60° C. is reduced.

However, the output characteristics are evaluated at only up to 60° C., and it is not clear whether the lithium ion capacitor can withstand high temperatures such as 85° C.

### Embodiment

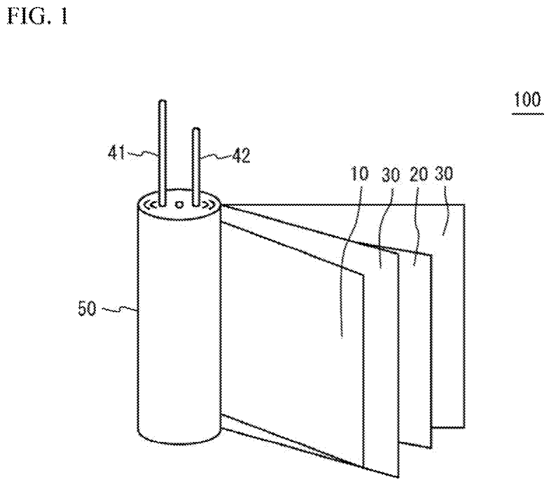

Hereinafter, with reference to the drawings, embodiments will be described. First, a lithium ion capacitor will be described as an exemplary electrochemical device. FIG. 1 is an exploded view of a lithium ion capacitor 100. As illustrated in FIG. 1, the lithium ion capacitor 100 includes a power storage element 50 in which a positive electrode 10, a negative electrode 20, and a separator 30 are rolled together while the separator 30 is sandwiched between the positive electrode 10 and the negative electrode 20. The power storage element 50 has a substantially cylindrical shape. A lead terminal 41 is coupled to the positive electrode 10. A lead terminal 42 is coupled to the negative electrode 20.

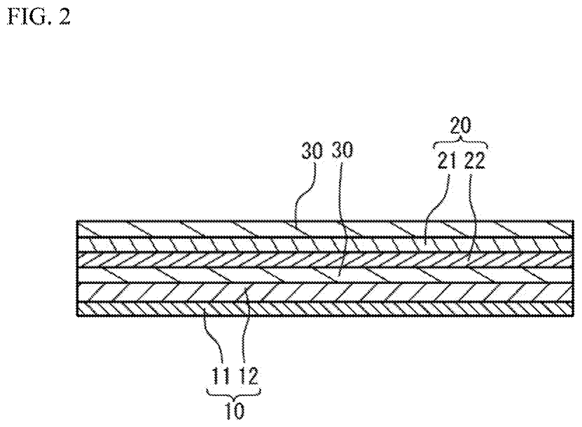

FIG. 2 is a cross-sectional view of the positive electrode 10, the negative electrode 20, and the separator 30 in a stacking direction. As illustrated in FIG. 2, the positive electrode 10 has a structure in which a positive electrode layer 12 is stacked on a face of a positive electrode collector 11. The separator 30 is stacked on the positive electrode layer 12 of the positive electrode 10. The negative electrode 20 is stacked on the separator 30. The negative electrode 20 has a structure in which a negative electrode layer 22 is stacked on a face of a negative electrode collector 21, the face being closer to the positive electrode 10. The separator 30 is stacked on the negative electrode collector 21 of the negative electrode 20. In the power storage element 50, a stack unit composed of the positive electrode 10, the separator 30, the negative electrode 20, and the separator 30 is rolled. The positive electrode layer 12 may be provided on both faces of the positive electrode collector 11. The negative electrode layer 22 may be provided on both faces of the negative electrode collector 21.

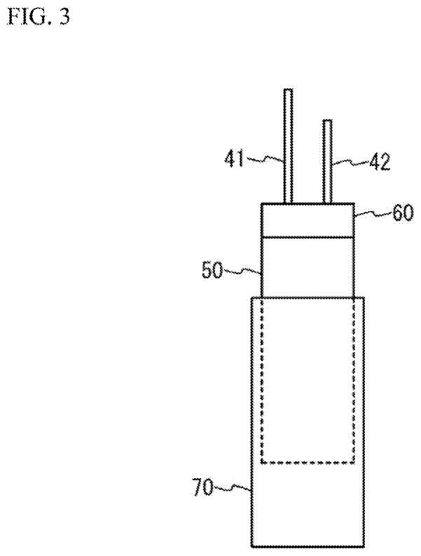

As illustrated in FIG. 3, the lead terminal 41 is inserted in a first one of two through holes of a sealing rubber 60, and the lead terminal 42 is inserted in a second one of the two through holes. The sealing rubber 60 has a substantially cylindrical shape, and has a diameter approximately equal to that of the power storage element 50. The power storage element 50 is housed in a container 70 that has a substantially cylindrical shape having a bottom.

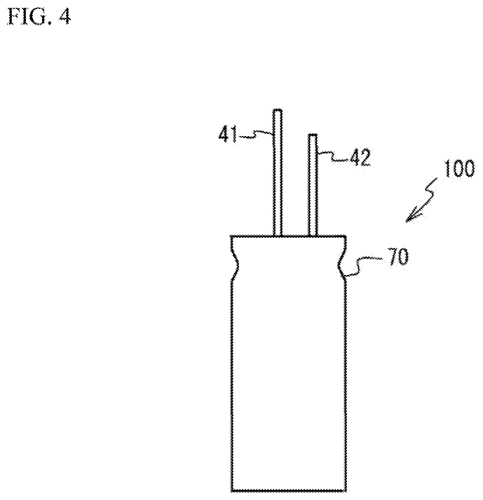

As illustrated in FIG. 4, the sealing rubber 60 is swaged around an opening of the container 70. Thus, the power storage element 50 is hermetically sealed. A nonaqueous electrolyte is sealed in the container 70. The active material of the positive electrode 10, the active material of the negative electrode 20, or the separator 30 is impregnated with the nonaqueous electrolyte.

(Positive Electrode) The positive electrode collector 11 is a metal foil such as an aluminum foil. The aluminum foil may be a perforated foil. The positive electrode layer 12 has a known material and a known structure which are used for an electrode layer of an electric double layered capacitor or a redox capacitor. For example, the positive electrode layer 12 includes an active material such as polyacene (PAS), polyaniline (PAN), activated carbon, carbon black, graphite, or carbon nanotube. The positive electrode layer 12 may include another component such as a conductive assistant or a binder which is used for the electrode layer of the electric double layered capacitor.

(Negative Electrode) The negative electrode collector 21 is a metal foil such as a copper foil. The copper foil may be a perforated foil. For example, the negative electrode layer 22 includes an active material such as hardly graphitizable carbon, graphite, tin oxide, or silicon oxide. The negative electrode layer 22 may include a conductive assistant such as carbon black or metal powder. The negative electrode layer 22 may include a binder such as polytetrafluoroethylene (PTFE), polyvinylidene fluoride (PVDF), or styrene butadiene rubber (SBR).

(Separator) The separator 30 is provided between the positive electrode 10 and the negative electrode 20, thereby inhibiting short circuit caused by contact of both electrodes. The separator 30 holds the nonaqueous electrolyte in holes thereof. Thus, the separator 30 has conductive paths between the electrodes. Examples of the material of the separator 30 include, but are not limited to, porous cellulose, porous polypropylene, porous polyethylene, and porous fluorine resin.

When the power storage element 50 and the nonaqueous electrolyte are housed and sealed in the container 70, a lithium metal sheet is electrically connected to the negative electrode 20. Thus, lithium in the lithium metal sheet dissolves in the nonaqueous electrolyte, and the negative electrode layer 22 of the negative electrode 20 is pre-doped with lithium ions. Thus, the electric potential of the negative electrode 20 is lower than that of the positive electrode 10 by approximately 3 V, before charge.

In the embodiment, the lithium ion capacitor 100 has a structure in which a rolled type of the power storage element 50 is sealed in the cylindrical container 70, but this does not intend to suggest any limitation. For example, the power storage element 50 may have a stacked structure. In this case, the container 70 may be a rectangular-shaped can.

(Nonaqueous Electrolyte) The nonaqueous electrolyte is made by dissolving an electrolyte in a nonaqueous solvent, and then adding an additive to the nonaqueous solvent.

(Nonaqueous Solvent) Cyclic carbonate and chain carbonate are used as the nonaqueous solvent. For example, the cyclic carbonate is cyclic carbonic ester such as propylene carbonate (PC) or ethylene carbonate (EC). Cyclic carbonic ester has a high permittivity, and thus sufficiently dissolves a lithium salt. The nonaqueous electrolyte using cyclic carbonic ester as the nonaqueous solvent has a high ionic conductivity. Therefore, when cyclic carbonate is used as the nonaqueous solvent, the lithium ion capacitor 100 has good initial characteristics. When cyclic carbonate is used as the nonaqueous solvent, electrochemical characteristics during operation of the lithium ion capacitor 100 are sufficiently stabilized after a coating film is formed on the negative electrode 20.

The chain carbonate is, for example, chain carbonic ester such as ethyl methyl carbonate (EMC) or diethyl carbonate (DEC). In the embodiment, the ratio of cyclic carbonate to chain carbonate in the nonaqueous solvent is configured to be 25:75 to 75:25 in volume ratio. The ratio of cyclic carbonate to chain carbonate in the nonaqueous solvent is preferably 25:75 to 60:40 in volume ratio, more preferably 25:75 to 50:50 in volume ratio.

(Electrolyte) Used as the electrolyte is a mixture of an imide-based lithium salt and a non-imide-based lithium salt. The imide-based lithium salt is, for example, LiFSI (lithium bis (fluorosulfonyl) imide). LiFSI improves the capacitance and the DCR of the lithium ion capacitor 100 at low temperatures.

The non-imide-based lithium salt is, for example, LiPF₆ (lithium hexafluorophosphate). Among generic lithium salts, LiPF₆ has a high dissociation constant, thus achieving good initial characteristics (the capacitance and the DCR) of the lithium ion capacitor 100.

In the embodiment, the molar ratio of the imide-based lithium salt to the non-imide-based lithium salt in the electrolyte is configured to be 1:9 to 10:0. The molar ratio of the imide-based lithium salt to the non-imide-based lithium salt in the electrolyte is preferably 2:8 to 8:2, more preferably 3:7 to 6:4.

The concentration of the electrolyte in the nonaqueous solvent is preferably 0.8 mol/L to 1.6 mol/L. The concentration of the electrolyte in the nonaqueous solvent is preferably 0.9 mol/L or greater and 1.5 mol/L or less, more preferably 1.0 mol/L or greater and 1.4 mol/L or less.

(First Additive) To inhibit increase in the internal resistance when the lithium ion capacitor 100 is subjected to high temperature, a lithium oxalate salt is added, as a first additive, to the nonaqueous electrolyte. Examples of the lithium oxalate salt include, but are not limited to, lithium bis (oxalato) borate (LiB(C₂O₄)₂), lithium difluoro bis (oxalato) phosphate (LiPF₂ (C₂O₄)₂), and lithium tetrafluoro (oxalato) phosphate (LiPF₄ (C₂O₄)).

The reduction potentials for these lithium oxalate salts are higher than that of the nonaqueous solvent. Thus, these lithium oxalate salts react with the negative electrode 20 to form a stable coating film.

To achieve sufficient effect of the first additive, the concentration of the first additive preferably has a lower limit. When the concentration of the first additive in the electrolytic solution is excessively high, a thick coating film may be formed on the negative electrode 20. Thus, the initial resistance may become high, and the change in the internal resistance may also become large. Therefore, the concentration of the first additive in the electrolytic solution preferably has an upper limit. In the embodiment, the concentration of the first additive in the electrolytic solution is configured to be 0.1 wt % to 2.0 wt %. The concentration of the first additive in the electrolytic solution is preferably 0.2 wt % or greater and 1.5 wt % or less, more preferably 0.3 wt % or greater and 1.0 wt % or less.

(Second Additive) In some cases, an ester compound such as, but not limited to, carbonic ester or sulfonic ester, of which the reductive decomposition potential is higher than that of the nonaqueous solvent, may be added, as a second additive, to the electrolytic solution. Examples of the carbonic ester include, but are not limited to, vinylene carbonate (VC) and fluoro ethylene carbonate (FEC). Examples of the sulfonic ester include, but are not limited to, 1,3-propane sultone (1,3-PS).

However, when the concentration of carbonic ester or sulfonic ester in the nonaqueous electrolyte is excessively high, the internal resistance of the lithium ion capacitor 100 at high temperature may be high. Thus, the concentration of the second additive in the electrolytic solution is preferably configured to be 0.1 wt % or less.

In the embodiment, as described above, the electrolyte including the imide-based lithium salt and the non-imide-based lithium salt at a molar ratio of 1:9 to 10:0 is dissolved in the electrolytic solution at a concentration of 0.8 mol/L to 1.6 mol/L, and the nonaqueous solvent including cyclic carbonate and chain carbonate at a volume ratio of 25:75 to 75:25 is used. This configuration improves the characteristics such as the capacitance and the DCR of the lithium ion capacitor 100 at low temperature.

In addition, the concentration of the lithium oxalate salt added to the electrolytic solution is configured to be 0.1 wt % to 2.0 wt %. This configuration inhibits increase in the internal resistance of the lithium ion capacitor 100 at high temperature.

The embodiment focuses on the electrolytic solution of the lithium ion capacitor among electrochemical devices, but does not intend to suggest any limitation. For example, the nonaqueous electrolyte of the embodiment may be used as electrolytic solutions of other electrochemical devices such as electric double layered capacitors.

### EXAMPLES

Lithium ion capacitors were fabricated in accordance with the above-described embodiment, and the characteristics of the fabricated lithium ion capacitors were examined. Table 1 through Table 4 list test conditions for examples and comparative examples.

TABLE 1

| | Type of electrolyte | | Type of nonaqueous solvent | | | | Concentration |
|---|---|---|---|---|---|---|---|
| | LiFSI | LiPF₆ | PC | EC | EMC | DEC | of electrolyte |
| | [mol %] | [mol %] | [vol %] | [vol %] | [vol %] | [vol %] | [mol/L] |
| Example 1 | 10 | 90 | 40 | 0 | 60 | 0 | 1.1 |
| Example 2 | 20 | 80 | 40 | 0 | 60 | 0 | 1.1 |
| Example 3 | 30 | 70 | 40 | 0 | 60 | 0 | 1.1 |
| Example 4 | 40 | 60 | 40 | 0 | 60 | 0 | 1.1 |
| Example 5 | 50 | 50 | 40 | 0 | 60 | 0 | 1.1 |
| Example 6 | 60 | 40 | 40 | 0 | 60 | 0 | 1.1 |
| Example 7 | 70 | 30 | 40 | 0 | 60 | 0 | 1.1 |
| Example 8 | 80 | 20 | 40 | 0 | 60 | 0 | 1.1 |
| Example 9 | 90 | 10 | 40 | 0 | 60 | 0 | 1.1 |
| Example 10 | 100 | 0 | 40 | 0 | 60 | 0 | 1.1 |
| Example 11 | 40 | 60 | 75 | 0 | 25 | 0 | 1.1 |
| Example 12 | 40 | 60 | 60 | 0 | 40 | 0 | 1.1 |
| Example 13 | 40 | 60 | 50 | 0 | 50 | 0 | 1.1 |
| Example 14 | 40 | 60 | 25 | 0 | 75 | 0 | 1.1 |
| Example 15 | 40 | 60 | 40 | 0 | 60 | 0 | 0.8 |
| Example 16 | 40 | 60 | 40 | 0 | 60 | 0 | 1.3 |
| Example 17 | 40 | 60 | 40 | 0 | 60 | 0 | 1.5 |
| Example 18 | 40 | 60 | 40 | 0 | 60 | 0 | 1.6 |
| Example 19 | 40 | 60 | 40 | 0 | 60 | 0 | 1.1 |
| Example 20 | 40 | 60 | 40 | 0 | 60 | 0 | 1.1 |
| Example 21 | 40 | 60 | 40 | 0 | 60 | 0 | 1.1 |
| Example 22 | 40 | 60 | 30 | 10 | 30 | 30 | 1.1 |
| Example 23 | 40 | 60 | 45 | 30 | 15 | 10 | 1.1 |
| Example 24 | 40 | 60 | 40 | 0 | 60 | 0 | 1.1 |
| Example 25 | 40 | 60 | 40 | 0 | 60 | 0 | 1.1 |
| Example 26 | 40 | 60 | 40 | 0 | 60 | 0 | 1.1 |
| Example 27 | 40 | 60 | 40 | 0 | 60 | 0 | 1.1 |
| Example 28 | 40 | 60 | 40 | 0 | 60 | 0 | 1.1 |

TABLE 2

| | Type of electrolyte | | Type of nonaqueous solvent | | | | Concentration |
|---|---|---|---|---|---|---|---|
| | LiFSI | LiPF₆ | PC | EC | EMC | DEC | of electrolyte |
| | [mol %] | [mol %] | [vol %] | [vol %] | [vol %] | [vol %] | [mol/L] |
| Comparative | 0 | 100 | 40 | 0 | 60 | 0 | 1.1 |
| example 1 | | | | | | | |
| Comparative | 40 | 60 | 100 | 0 | 0 | 0 | 1.1 |
| example 2 | | | | | | | |
| Comparative | 40 | 60 | 80 | 0 | 20 | 0 | 1.1 |
| example 3 | | | | | | | |
| Comparative | 40 | 60 | 20 | 0 | 80 | 0 | 1.1 |
| example 4 | | | | | | | |
| Comparative | 40 | 60 | 40 | 0 | 60 | 0 | 0.7 |
| example 5 | | | | | | | |
| Comparative | 40 | 60 | 40 | 0 | 60 | 0 | 1.7 |
| example 6 | | | | | | | |
| Comparative | 40 | 60 | 40 | 0 | 60 | 0 | 1.1 |
| example 7 | | | | | | | |
| Comparative | 40 | 60 | 40 | 0 | 60 | 0 | 1.1 |
| example 8 | | | | | | | |

TABLE 3

| | |
|---|---|
| First additive | Second additive |

| | | Added | | Added |
|---|---|---|---|---|
| | | amount | | amount |
| | Type | [wt %] | Type | [wt %] |
| Example 1 | LiB(C₂O₄)₂ | 1.0 | — | — |
| Example 2 | LiB(C₂O₄)₂ | 1.0 | — | — |
| Example 3 | LiB(C₂O₄)₂ | 1.0 | — | — |
| Example 4 | LiB(C₂O₄)₂ | 1.0 | — | — |
| Example 5 | LiB(C₂O₄)₂ | 1.0 | — | — |
| Example 6 | LiB(C₂O₄)₂ | 1.0 | — | — |
| Example 7 | LiB(C₂O₄)₂ | 1.0 | — | — |
| Example 8 | LiB(C₂O₄)₂ | 1.0 | — | — |
| Example 9 | LiB(C₂O₄)₂ | 1.0 | — | — |
| Example 10 | LiB(C₂O₄)₂ | 1.0 | — | — |
| Example 11 | LiB(C₂O₄)₂ | 1.0 | — | — |
| Example 12 | LiB(C₂O₄)₂ | 1.0 | — | — |
| Example 13 | LiB(C₂O₄)₂ | 1.0 | — | — |
| Example 14 | LiB(C₂O₄)₂ | 1.0 | — | — |
| Example 15 | LiB(C₂O₄)₂ | 1.0 | — | — |
| Example 16 | LiB(C₂O₄)₂ | 1.0 | — | — |
| Example 17 | LiB(C₂O₄)₂ | 1.0 | — | — |
| Example 18 | LiB(C₂O₄)₂ | 1.0 | — | — |
| Example 19 | LiB(C₂O₄)₂ | 0.1 | — | — |
| Example 20 | LiB(C₂O₄)₂ | 0.5 | — | — |
| Example 21 | LiB(C₂O₄)₂ | 2.0 | — | — |
| Example 22 | LiB(C₂O₄)₂ | 1.0 | — | — |
| Example 23 | LiB(C₂O₄)₂ | 1.0 | — | — |
| Example 24 | LiPF₂(C₂O₄)₂ | 1.0 | — | — |
| Example 25 | LiPF₄(C₂O₄) | 1.0 | — | — |
| Example 26 | LiB(C₂O₄)₂ | 1.0 | VC | 0.1 |
| Example 27 | LiB(C₂O₄)₂ | 1.0 | FEC | 0.1 |
| Example 28 | LiB(C₂O₄)₂ | 1.0 | 1,3-PS | 0.1 |

TABLE 4

| | |
|---|---|
| First additive | Second additive |

| | | Added | | Added |
|---|---|---|---|---|
| | | amount | | amount |
| | Type | [wt %] | Type | [wt %] |
| Comparative | LiB(C₂O₄)₂ | 1.0 | — | — |
| example 1 | | | | |
| Comparative | LiB(C₂O₄)₂ | 1.0 | — | — |
| example 2 | | | | |
| Comparative | LiB(C₂O₄)₂ | 1.0 | — | — |
| example 3 | | | | |
| Comparative | LiB(C₂O₄)₂ | 1.0 | — | — |
| example 4 | | | | |
| Comparative | LiB(C₂O₄)₂ | 1.0 | — | — |
| example 5 | | | | |
| Comparative | LiB(C₂O₄)₂ | 1.0 | — | — |
| example 6 | | | | |
| Comparative | — | — | — | — |
| example 7 | | | | |
| Comparative | LiB(C₂O₄)₂ | 3.0 | — | — |
| example 8 | | | | |

(Example 1) Activated carbon was used as the active material of the positive electrode 10. Carboxymethylcellulose and styrene-butadiene rubber were used as a binder, and slurry was prepared. The prepared slurry was applied onto a perforated aluminum foil and was shaped into a sheet. Hardly graphitizable carbon made of phenolic resin was used as the active material of the negative electrode 20. Carboxymethylcellulose and styrene-butadiene rubber were used as a binder, and slurry was prepared. The prepared slurry was applied onto a perforated copper film, and then shaped into a sheet. The cellulose-based separator 30 was sandwiched between the electrodes 10 and 20. The lead terminal 41 was connected to the positive electrode collector 11 by ultrasonic welding. The lead terminal 42 was connected to the negative electrode collector 21 by ultrasonic welding. Thereafter, the positive electrode 10, the separator 30, and the negative electrode 20 were rolled. The power storage element 50 was fixed by an adhesive tape made of polyimide. The sealing rubber 60 was attached to the power storage element 50, and the power storage element 50 and the sealing rubber 60 were dried in vacuum atmosphere at approximately 180° C. Thereafter, a lithium foil was attached to the negative electrode 20, and the power storage element 50 was housed in the container 70.

Thereafter, prepared was the nonaqueous electrolyte made by dissolving the electrolyte including LiFSI and LiPF₆ at a molar ratio of 1:9 in the nonaqueous solvent including PC and EMC at a volume ratio of 4:6. The concentration of the electrolyte in the nonaqueous electrolyte was 1.1 mol/L. Furthermore, lithium bis (oxalato) borate (LiB(C₂O₄)₂) was added, as the first additive, to the nonaqueous electrolyte at a concentration of 1.0 wt %. Then, the resulting nonaqueous electrolyte was injected into the container 70, and a portion of the sealing rubber 60 was swaged. The lithium ion capacitor 100 was made in the above-described manner.

(Example 2) In an example 2, LiFSI and LiPF₆ were mixed at a molar ratio of 2:8. Other conditions were the same as those of the example 1.

(Example 3) In an example 3, LiFSI and LiPF₆ were mixed at a molar ratio of 3:7. Other conditions were the same as those of the example 1.

(Example 4) In an example 4, LiFSI and LiPF₆ were mixed at a molar ratio of 4:6. Other conditions were the same as those of the example 1.

(Example 5) In an example 5, LiFSI and LiPF₆ were mixed at a molar ratio of 5:5. Other conditions were the same as those of the example 1.

(Example 6) In an example 6, LiFSI and LiPF₆ were mixed at a molar ratio of 6:4. Other conditions were the same as those of the example 1.

(Example 7) In an example 7, LiFSI and LiPF₆ were mixed at a molar ratio of 7:3. Other conditions were the same as those of the example 1.

(Example 8) In an example 8, LiFSI and LiPF₆ were mixed at a molar ratio of 8:2. Other conditions were the same as those of the example 1.

(Example 9) In an example 9, LiFSI and LiPF₆ were mixed at a molar ratio of 9:1. Other conditions were the same as those of the example 1.

(Example 10) In an example 10, LiFSI and LiPF₆ were mixed at a molar ratio of 10:0. Other conditions were the same as those of the example 1.

(Example 11) In an example 11, PC and EMC were mixed at a volume ratio of 75:25. Other conditions were the same as those of the example 4.

(Example 12) In an example 12, PC and EMC were mixed at volume ratio of 60:40. Other conditions were the same as those of the example 4.

(Example 13) In an example 13, PC and EMC were mixed at a volume ratio of 50:50. Other conditions were the same as those of the example 4.

(Example 14) In an example 14, PC and EMC were mixed at volume ratio of 25:75. Other conditions were the same as those of the example 4.

(Example 15) In an example 15, the concentration of the electrolyte in the nonaqueous electrolyte was 0.8 mol/L. Other conditions were the same as those of the example 4.

(Example 16) In an example 16, the concentration of the electrolyte in the nonaqueous electrolyte was 1.3 mol/L. Other conditions were the same as those of the example 4.

(Example 17) In an example 17, the concentration of the electrolyte in the nonaqueous electrolyte was 1.5 mol/L. Other conditions were the same as those of the example 4.

(Example 18) In an example 18, the concentration of the electrolyte in the nonaqueous electrolyte was 1.6 mol/L. Other conditions were the same as those of the example 4.

(Example 19) In an example 19, the concentration of the first additive in the nonaqueous electrolyte was 0.1 wt %. Other conditions were the same as those of the example 4.

(Example 20) In an example 20, the concentration of the first additive in the nonaqueous electrolyte was 0.5 wt %. Other conditions were the same as those of the example 4.

(Example 21) In an example 21, the concentration of the first additive in the nonaqueous electrolyte was 2.0 wt %. Other conditions were the same as those of the example 4.

(Example 22) In an example 22, the composition of the nonaqueous solvent was PC:EC:EMC:DEC=30:10:30:30 in volume ratio. Other conditions were the same as those of the example 4.

(Example 23) In an example 23, the composition of the nonaqueous solvent was PC:EC:EMC:DEC=45:30:15:10 in volume ratio. Other conditions were the same as those of the example 4.

(Example 24) In an example 24, lithium difluoro bis (oxalato) phosphate (LiPF₂ (C₂O₄)₂) was used as the first additive. Other conditions were the same as those of the example 4.

(Example 25) In an example 25, lithium tetrafluorooxalatophosphate (LiPF₄ (C₂O₄)) was used as the first additive. Other conditions were the same as those of the example 4.

(Example 26) In an example 26, vinylene carbonate (VC) was used as the second additive. The concentration of the vinylene carbonate in the nonaqueous electrolyte was 0.1 wt %. Other conditions were the same as those of the example 4.

(Example 27) In an example 27, fluoro ethylene carbonate (FEC) was used as the second additive. The concentration of the fluoro ethylene carbonate in the nonaqueous electrolyte was 0.1 wt %. Other conditions were the same as those of the example 4.

(Example 28) In an example 28, 1,3-propane sultone (1,3-PS) was used as the second additive. The concentration of the 1,3-propane sultone in the nonaqueous electrolyte was 0.1 wt %. Other conditions were the same as those of example 4.

(Comparative example 1) In a comparative example 1, LiFSI and LiPF₆ were mixed at a molar ratio of 0:100. Other conditions were the same as those of the example 1.

(Comparative example 2) In a comparative example 2, PC and EMC were mixed at a volume ratio of 100:0. Other conditions were the same as those of the example 4.

(Comparative example 3) In a comparative example 3, PC and EMC were mixed at a volume ratio of 80:20. Other conditions were the same as those of the example 4.

(Comparative example 4) In a comparative example 4, PC and EMC were mixed at a volume ratio of 20:80. Other conditions were the same as those of the example 4.

(Comparative example 5) In a comparative example 5, the concentration of the electrolyte in the nonaqueous electrolyte was 0.7 mol/L. Other conditions were the same as those of the example 4.

(Comparative example 6) In a comparative example 6, the concentration of the electrolyte in the nonaqueous electrolyte was 1.7 mol/L. Other conditions were the same as those of the example 4.

(Comparative example 7) In a comparative example 7, none of the first additive and the second additive was added to the nonaqueous electrolyte. Other conditions were the same as those of the example 4.

(Comparative example 8) In a comparative example 8, the concentration of the first additive in the nonaqueous electrolyte was 3.0 wt %. Other conditions were the same as those of the example 4.

(Evaluation method) Lithium ion capacitors of the examples 1 to 28 and the comparative examples 1 to 8 were fabricated. Then, the electrostatic capacitance and the DCR (the internal resistance) at a room temperature (25° C.) were measured as initial characteristics.

The cell was left at −40° C. for two hours, and then, the electrostatic capacitance and the DCR were measured at −40° C. Low-temperature characteristics were then evaluated based on the change ratios of these values from 25° C.

To evaluate the high-temperature reliability, a float test was conducted. In the float test, the lithium ion capacitors were continuously charged at 3.8 V for 1000 hours in a thermostatic tank of 85° C. After the float test, the lithium ion capacitors were cooled to the room temperature. Thereafter, the electrostatic capacitance and the DCR were measured, and the change ratios of the electrostatic capacitance and the DCR after the float test to the electrostatic capacitance and the DCR before the float test were calculated.

Table 5 and Table 6 list results of the examples and the comparative examples.

TABLE 5

| | Cell characteristics | | Cell characteristics | | | |
|---|---|---|---|---|---|---|
| | at 25° C. | | at −40° C. | | Float reliability | |
| | Electrostatic | | Capacity | Resistance | Capacity | Resistance |
| | capacitance | DCR | retention rate | increase rate | retention rate | increase rate |
| | [F] | [mΩ] | [%] | [%] | [%] | [%] |
| Example 1 | 41 | 75 | 61 | 1920 | 89 | 160 |
| Example 2 | 41 | 74 | 63 | 1850 | 89 | 160 |
| Example 3 | 41 | 73 | 63 | 1800 | 89 | 160 |
| Example 4 | 41 | 72 | 63 | 1780 | 89 | 160 |
| Example 5 | 41 | 70 | 63 | 1800 | 89 | 160 |
| Example 6 | 41 | 69 | 63 | 1820 | 89 | 170 |
| Example 7 | 41 | 68 | 63 | 1840 | 88 | 170 |
| Example 8 | 41 | 68 | 63 | 1840 | 88 | 170 |
| Example 9 | 41 | 67 | 63 | 1850 | 88 | 180 |
| Example 10 | 40 | 67 | 63 | 1850 | 89 | 180 |
| Example 11 | 40 | 79 | 60 | 1990 | 89 | 130 |
| Example 12 | 40 | 75 | 61 | 1920 | 89 | 140 |
| Example 13 | 39 | 73 | 62 | 1860 | 89 | 150 |
| Example 14 | 38 | 75 | 65 | 1620 | 87 | 190 |
| Example 15 | 39 | 80 | 63 | 1990 | 87 | 170 |
| Example 16 | 41 | 70 | 63 | 1630 | 89 | 160 |
| Example 17 | 41 | 72 | 63 | 1760 | 89 | 160 |
| Example 18 | 41 | 79 | 63 | 1970 | 89 | 160 |
| Example 19 | 41 | 72 | 63 | 1600 | 81 | 190 |
| Example 20 | 41 | 72 | 63 | 1620 | 89 | 160 |
| Example 21 | 41 | 79 | 62 | 1960 | 82 | 190 |
| Example 22 | 41 | 72 | 61 | 1860 | 89 | 180 |
| Example 23 | 41 | 74 | 62 | 1980 | 89 | 160 |
| Example 24 | 41 | 70 | 63 | 1550 | 82 | 190 |
| Example 25 | 41 | 70 | 63 | 1520 | 83 | 180 |
| Example 26 | 41 | 72 | 63 | 1880 | 83 | 200 |
| Example 27 | 41 | 72 | 63 | 1820 | 84 | 190 |
| Example 28 | 41 | 72 | 63 | 1930 | 83 | 200 |

TABLE 6

| | Cell characteristics | | Cell characteristics | | | |
|---|---|---|---|---|---|---|
| | at 25° C. | | at −40° C. | | Float reliability | |
| | Electrostatic | | Capacity | Resistance | Capacity | Resistance |
| | capacitance | DCR | retention rate | increase rate | retention rate | increase rate |
| | [F] | [mΩ] | [%] | [%] | [%] | [%] |
| Comparative | 39 | 77 | 59 | 2010 | 89 | 160 |
| example 1 | | | | | | |
| Comparative | 41 | 85 | 49 | 2200 | 89 | 130 |
| example 2 | | | | | | |
| Comparative | 40 | 81 | 59 | 2060 | 89 | 130 |
| example 3 | | | | | | |
| Comparative | 37 | 86 | 68 | 1540 | 86 | 210 |
| example 4 | | | | | | |
| Comparative | 35 | 92 | 67 | 2080 | 86 | 170 |
| example 5 | | | | | | |
| Comparative | 41 | 91 | 63 | 2460 | 88 | 170 |
| example 6 | | | | | | |
| Comparative | 41 | 72 | 63 | 1600 | 24 | 2900 |
| example 7 | | | | | | |
| Comparative | 41 | 86 | 63 | 2150 | 67 | 290 |
| example 8 | | | | | | |

(Initial characteristics) When the electrostatic capacitance was within 40 F±5%, and the DCR was 80 mΩ or less, it was determined that the initial characteristics were good. Otherwise, it was determined that the initial characteristics were poor.

As seen from the results of the examples 1 to 10 and the comparative example 1, the DCR at 25° C. decreases with increase in the molar ratio of LiFSI in the electrolyte. However, it was confirmed that the initial characteristics hardly change when the molar ratio of LiFSI increases to a certain level.

As seen from the results of the examples 4 and 11 to 14, and the comparative examples 2 to 4, it was observed that as chain carbonate (EMC) was added to cyclic carbonate (PC), the electrostatic capacitance at 25° C. slightly decreased, and the DCR at 25° C. decreased. However, it was observed that when the volume ratio of chain carbonate (PC) in the nonaqueous solvent exceeded 60%, the DCR started increasing, and when the volume ratio was above 80%, the DCR was higher than the DCR when no chain carbonate (PC) was added, and the DCR at room temperature or higher deteriorated.

As seen from the results of the examples 4 and 15 to 18 and the comparative examples 5 and 6, it was observed that even when the concentration of the electrolyte in the nonaqueous electrolyte was lower than or higher than a certain range, the electrostatic capacitance at 25° C. decreased or the DCR at 25° C. increased.

(Low-temperature characteristics) When the capacity retention rate was 60% or greater and the resistance increase rate was 2000% or less, it was determined that the low temperature characteristics at −40° C. were good. Otherwise, it was determined that the low temperature characteristics at −40° C. were poor.

The capacity retention rate is a ratio of the electrostatic capacitance at −40° C. to the electrostatic capacitance at 25° C. (i.e., the capacity retention rate=(the electrostatic capacitance at −40° C./the electrostatic capacitance at 25° C.)×100 [%]). The resistance increase rate is a ratio of the DCR at −40° C. to the DCR at 25° C. (i.e., the resistance increase rate=(the DCR at −40° C./the DCR at 25° C.)×100 [%]). In the comparative example 1 in which 100 mol % of LiPF₆ was used as the electrolyte, the resistance increase rate at −40° C. was 2010%, and the above criterion (2000% or less) was not satisfied.

In contrast, in the example 1 in which 10 mol % of LiFSI was added to the electrolyte, it was confirmed that the resistance increase rate at −40° C. satisfied the criterion (2000% or less). Also in the examples 2 to 10 in which the concentration of LiFSI in the electrolyte was 20 mol % to 100 mol %, the resistance increase rate at −40° C. satisfied the criterion (2000% or less).

Thus, it was confirmed that it is effective in inhibiting increase in the resistance of the lithium ion capacitor 100 at low temperature to mix the imide-based lithium salt (LiFSI) and the non-imide-based lithium salt (LiPF₆) at a molar ratio of 1:9 to 10:0.

In the examples 4 and 11 to 14 in which a volume ratio of cyclic carbonate (PC) to chain carbonate (EMC) was within a range of 25:75 to 75:25, it was observed that the resistance increase rate satisfied the above criterion (2000% or less) and the resistance increase rate decreased as chain carbonate (EMC) increased.

However, in the comparative examples 2 and 3 in which the volume ratio of cyclic carbonate (PC) to chain carbonate (EMC) was out of the range of 25:75 to 75:25, the resistance increase rate did not satisfy the above criterion (2000% or less).

Thus, it was confirmed that it is effective in limiting the resistance increase rate at −40° C. to 2000% or less to make the volume ratio of chain carbonate to cyclic carbonate in the nonaqueous solvent 75:25 to 25:75. In the examples 4 and 15 to 18 in which the concentration of the electrolyte in the nonaqueous electrolyte was 0.8 mol/L to 1.6 mol/L, the resistance increase rate at −40° C. was 2000% or less. In contrast, in the comparative examples 5 and 6 in which the concentration of the electrolyte was greater than the range of 0.8 mol/L to 1.6 mol/L, the resistance increase rate at −40° C. was greater than 2000%.

Thus, it was confirmed that it is effective in limiting the resistance increase rate at −40° C. to 2000% or less to make the concentration of the electrolyte in the nonaqueous electrolyte 0.8 mol/L to 1.6 mol/L.

(High-temperature reliability) When the capacity retention rate was 80% or greater and the DCR increase rate was 200% or less, it was determined that the high-temperature reliability was sufficient. Otherwise, it was determined that the high-temperature reliability was insufficient. The capacity retention rate is a ratio of the electrostatic capacitance after the float test to the electrostatic capacitance before the float test (i.e., the capacity retention rate=(the electrostatic capacitance after the float test/the electrostatic capacitance before the float test)×100[%]). In addition, the internal resistance increase rate is a ratio of the internal resistance after the float test to the internal resistance before the float test (i.e., the internal resistance increase rate=(the internal resistance after the float test/the internal resistance before the float test)×100[%]).

In the examples 1 to 28 and the comparative examples 1 to 6, the results satisfied the criteria. However, as the amount of chain carbonate (EMC) in the electrolytic solution increases, the high-temperature reliability gradually deteriorates. For example, in the comparative example 4 in which the volume ratio of cyclic carbonate (PC) to chain carbonate (EMC) was 20:80, the resistance increase rate did not satisfy the criterion (200% or less). Thus, it was confirmed that it is effective in maintaining the high-temperature reliability to make the volume ratio of cyclic carbonate (PC) to chain carbonate (EMC) 25:75 to 75:25.

When SBR is used for a binder of the positive electrode layer 12 or the negative electrode layer 22, and approximately 20 vol % or greater of chain carbonate (EMC) is contained in the nonaqueous solvent, the RED value based on Hansen parameters is less than 1. However, the results reveal that sufficiently high high-temperature reliability is obtained even in this case.

In the examples 19 to 21, the concentration of the lithium oxalate salt, which is the first additive, in the nonaqueous electrolyte was 0.1 wt % to 2.0wt %. This configuration made the resistance increase rate satisfy the criterion (200% or less). In contrast, in the comparative examples 7 and 8 in which the concentration of the first additive was greater than the range of 0.1 wt % to 2.0 wt %, the resistance increase rate was greater than 200%.

For example, in the comparative example 8 in which the added amount of the first additive was large, 3 wt %, the resistance increase rate was greater than 200%. In the comparative example 7 in which the first additive was not added to the nonaqueous electrolyte at all, the resistance increase rate was 2900%, and the high-temperature reliability was very bad.

In the examples 26 to 28, carbonic ester or sulfonic ester, of which the reductive decomposition potential is higher than that of the nonaqueous solvent, was used as the second additive, and the second additive was added to the nonaqueous electrolyte at a concentration of 0.1 wt % to balance the electrical characteristics and the high-temperature reliability.

However, for the high-temperature reliability, compared with the examples 26 to 28 in which the concentration of the second additive was 0.1 wt %, the example 4 in which no second additive was added had good values of the capacity retention rate and the resistance increase rate. Thus, to inhibit the high-temperature reliability from further deteriorating from those of the examples 26 to 28, the concentration of the second additive in the nonaqueous electrolyte is preferably 0.1 wt % or less.

Although the embodiments of the present invention have been described in detail, it is to be understood that the various change, substitutions, and alterations could be made hereto without departing from the spirit and scope of the invention.

What is claimed is:

1. An electrolytic solution for an electrochemical device, comprising:
an electrolytic solution in which an electrolyte is dissolved in a solvent, wherein
the solvent includes a cyclic carbonate and a chain carbonate at a volume ratio of 25:75 to 75:25,
the electrolyte is dissolved in the electrolytic solution at a concentration of 0.8 mol/L to 1.6 mol/L, and includes an imide-based lithium salt and a non-imide-based lithium salt at a molar ratio of 1:9 to 10:0, and
a lithium oxalate salt is added to the electrolytic solution at a concentration of 0.1 wt % to 2.0 wt %.

2. The electrolytic solution according to claim 1, wherein
the imide-based lithium salt is lithium bis (fluorosulfonyl) imide, and the non-imide-based lithium salt is lithium hexafluorophosphate.

3. The electrolytic solution according to claim 1, wherein
the cyclic carbonate is propylene carbonate or ethylene carbonate, and
the chain carbonate is ethyl methyl carbonate or diethyl carbonate.

4. The electrolytic solution according to claim 1, wherein
an ester compound having a reductive decomposition potential higher than that of the solvent is added to the electrolytic solution at a concentration of 0.1 wt % or less.

5. The electrolytic solution according to claim 4, wherein
the ester compound is one of carbonic ester and sulfonic ester.

6. An electrochemical device comprising:
a power storage element in which a separator is sandwiched between a positive electrode and a negative electrode,
wherein at least one of an active material of the positive electrode, an active material of the negative electrode, and the separator is impregnated with an electrolytic solution, and
the electrolytic solution includes:
an electrolytic solution in which an electrolyte is dissolved in a solvent, wherein
the solvent includes a cyclic carbonate and a chain carbonate at a volume ratio of 25:75 to 75:25,
the electrolyte is dissolved in the electrolytic solution at a concentration of 0.8 mol/L to 1.6 mol/L, and includes an imide-based lithium salt and a non-imide-based lithium salt at a molar ratio of 1:9 to 10:0, and
a lithium oxalate salt is added to the electrolytic solution at a concentration of 0.1 wt % to 2.0 wt %.
